(19) United States
(12) Patent Application Publication
(10) Pub. No.: US 2017/0124205 A1
(43) Pub. Date: May 4, 2017

(54) SMART CACHE FOR TRAVEL SEARCH COMPUTER SYSTEM HOSTING A TRAVEL META-SEARCH ENGINE

(71) Applicant: GoEuro Corporation, Astoria, NY (US)

(72) Inventors: Naren SHAAM, Berlin (DE); Patrick SCHWEIZER, Berlin (DE); Benjamin EMDE, Waldeck (DE)

(21) Appl. No.: 15/312,153

(22) PCT Filed: May 28, 2014
(86) PCT No.: PCT/EP2014/061161

§ 371 Date: Nov. 17, 2016

(51) Int. Cl. G06F 17/30

(52) U.S. Cl. CPC G06F 17/30867; G06F 17/3087; G06F 17/3048; G06F 17/30902

(57) ABSTRACT

A computer-implemented method to retrieve results for a travel search task executed on a computer system hosting a travel meta-search engine comprises obtaining a travel search task specifying one or more values of each search task parameter of a set travel search task parameters, obtaining search task normalization information for the search task, normalizing the search task, wherein normalizing the search task includes adapting at least one search parameter of the search task based on the search task normalization information, determining a cache key corresponding to the normalized travel search task, determining if a cache of the computer system hosting a travel meta-search engine includes a search result for the normalized search task, the cache including search results of previous travel search tasks indexed by a cache key and if the cache includes a search result for the normalized search task, retrieving the search result from the cache.

### TECHNICAL FIELD

The present disclosure relates to a travel meta-search engine. In particular, the present disclosure relates to a smart cache for a travel meta-search engine.

### BACKGROUND

Different providers of transport services (e.g., bus or railway companies, airlines, or travel aggregators) provide web interfaces that can be used to request travel information (e.g., itineraries, availabilities and prices) from the respective provider or a group of providers. However, a request to such interface usually only yields travel information offered by the particular provider (or by a set of similar providers, for example airline companies). As users are often interested in different options for a particular route, numerous providers' interfaces have to be visited subsequently. In order to serve results faster in a more convenient manner, travel meta-search engines have been developed which provide a single interface to a user to present travel search results from a multitude of providers of transport services. This is not a trivial task. The number of different candidate routes for a particular travel search request can be huge. In particular, for a particular journey (e.g., from Paris to Munich) one can use several different transportation means (e.g., plane, bus, train). In addition, each route can be split into different legs, where each leg might include rides using the same transportation means. In other examples, different transportation means can be combined in a multiple leg journey (e.g., a metro ride from the outskirts of Paris to le Gare de l'est, followed by a ride with the TGV bullet train to Strasbourg, followed by a flight from Strasbourg to Munich and finally a ride with a regional train to Munich center). These and other complexities make the implementation of a travel meta-search engine (in particular if it covers multiple transportation means) technically challenging. For instance, multiple transportation means can be used to travel from a particular origin to a particular destination, where each of the multiple transportation means offers different route options. Moreover, different transportation providers can serve the different routes. For each or at least each group of this multitude of options a dedicated request to a provider's web interface can be required. This might cause a substantial amount of web traffic and result in substantial delays until data can be served to the requesting user.

### SUMMARY

In a first general aspect of the present disclosure a computer-implemented method to retrieve results for a travel search task executed on a computer system hosting a travel meta-search engine comprises obtaining a travel search task specifying one or more values of each travel search task parameter of a set of travel search task parameters, obtaining search task normalization information for the travel search task, normalizing the travel search task, wherein normalizing the travel search task includes adapting at least one travel search parameter of the travel search task based on the search task normalization information, determining a cache key corresponding to the normalized travel search task, determining if a cache of the computer system hosting a travel meta-search engine includes a travel search result for the normalized travel search task, the cache including travel search results of previous travel search tasks indexed by a cache key and if the cache includes a travel search result for the normalized travel search task, retrieving the travel search result from the cache.

In this manner, a frequency of travel search requests to external servers can be decreased (in some examples, few or even no new requests to external servers might be required to serve results in response to a particular travel search request). This can have several advantageous technical effects. Firstly, a reduced number of requests to remote servers can decrease web traffic and bandwidth requirements between a computer system hosting the travel meta-search engine and the remote servers hosting the multiple providers. Secondly, reliability of the services can be increased as some providers' interfaces can cope with only with a limited number of requests at a time. Reducing an amount of requests can reduce a risk of overburdening the providers' servers. Thirdly, connections to the servers hosting particular transport providers' systems can be unreliable, so reducing the frequency of requests can increase speed of the travel meta-search engine. Fourthly, by reducing a number of potentially time-consuming cross-system requests, the results for travel search queries can be served faster in many situations. Fifthly, a cache in the computer system serving the travel search results can be smaller compared to a system in which the travel search tasks are not normalized, as a particular search result can be served in reply to several different travel search requests.

The method of the first aspect can achieve some or all of these advantages in many circumstances by employing a smart cache mechanism whose structure is adapted in a particular manner to particularities travel searches. This allows the computer system hosting the travel meta-search engine to use search results from the cache in different situations instead of having to request them from external providers hosted on remote servers systems. In particular, it has been recognized that an exact hit for a predetermined set of search parameters might not be necessary for serving a useful result for a particular travel search task. For instance, even if a travel search request specifies a group of two travelers, a travel search result for a single traveler can still be useful. This information can be stored in the search task normalization information of a travel meta-search engine and a search task can be normalized accordingly. In other examples, a predetermined transport carrier can offer the same set of connections on every workday of the week at the same price. If in reply to a predetermined travel search task a particular connection of the predetermined transport carrier is a candidate connection, the search task normalization information can be used to adapt the set of search parameters by removing (or ignoring) the date from the set of search parameters. Then, it can be checked if the cache of the travel meta-search engine includes a hit for the particular connection regardless of the date (e.g., yesterday). If a corresponding travel search result can be found, it can be retrieved from the cache of the travel meta-search engine (possibly after an adaptation to reflect the travel search parameters of a current travel search request), thereby avoiding a resource inefficient and slow request to the external server hosting the interface of the transport carrier.

In a second aspect according to the first aspect, the computer-implemented method of claim 1 further includes if the cache does not include a travel search result for the normalized travel search task, retrieving the travel search result from a provider hosted on a computer system external to the computer system hosting the travel meta-search engine.

In a third aspect according to the first or second aspect, the method further comprises adapting the travel search result retrieved from the cache to take into account the adaptation of at least one travel search parameter in the normalizing operation. In this manner, it can be secured that the de-cached travel search results confirm to the travel search parameters of the current travel search task.

In a fourth aspect according to any one of the preceding aspects, adapting at least one travel search parameter of the travel search task includes changing the one or more values of the at least one travel search task parameter or removing the travel search parameter in the normalized travel search task, or marking the at least one travel search parameter to be ignored in the normalized travel search task.

In a fifth aspect according to any one of the preceding aspects, the travel search task is a provider-specific travel search task for retrieving travel data from a particular provider hosted on a computer system external to the computer system hosting the travel meta-search engine.

In a sixth aspect according to any one of the preceding aspects, the cache key specifies a set of attributes of the respective travel search result, wherein each attribute identifies one or more values of a travel search parameter of a travel search task for which the particular travel search result was retrieved.

In a seventh aspect according to the sixth aspect, the attributes can include one or more of a one way/round trip attribute, a non stop only attribute, an outbound date attribute, a return date attribute, a number of passengers attribute, a further description of the passengers attribute, a bonus cards of the passenger(s) attribute, an origin of passenger attribute, a language of passenger attribute, desired cabin type attribute, an origin attribute, a destination attribute and a departure time attribute.

In an eighth aspect according to any one of the preceding aspects, the search task normalization information for the travel search task is selected such that a probability is increased that travel search results retrieved from providers hosted on a computer system external to the computer system hosting the travel meta-search engine in response to the normalized travel search task can be re-used in future travel search tasks.

In a ninth aspect according to any one of the preceding aspects, the search task normalization information includes provider-specific information for one of a plurality of providers hosted on a computer system external to the computer system hosting the travel meta-search engine the travel meta-search engine retrieves travel search data from.

In a tenth aspect according to any one of the preceding aspects, each travel search result in the cache has a lifetime or an expiration date, the method further comprising removing the travel search result from the cache if the lifetime or the expiration date of the search result has passed.

In an eleventh aspect according to the tenth aspect, the lifetime or the expiration date for a particular search result is determined based on values of travel search parameters of the travel search task in response to which the particular travel search result is retrieved, based on information regarding the provider from which the particular travel search result is retrieved, based on parameters of the travel search result, or a combination of two or more of these factors.

In a twelfth aspect according to any one of the preceding aspects, the travel search task is one of one or more travel search tasks for a travel search request and the method further comprises obtaining the travel search request from a user, the travel search request specifying a set of travel search request parameters, defining the one or more travel search tasks for the obtained travel search result, each travel search task specifying a set of travel search parameters;

obtaining search task normalization information for each of the travel search tasks, normalizing each travel search task, determining a cache key corresponding to each normalized travel search task, determining if the cache of the computer system hosting a travel meta-search engine includes a travel search result for the normalized travel search tasks and if the cache includes travel search result for the normalized travel search tasks, retrieving the travel search result from the cache.

In a thirteenth aspect according to any one of the preceding aspects, the travel meta-search engine is configured to provide travel search results for one or more or two or more different transportation means.

In a second general aspect of the present disclosure a computer system for retrieving results for a travel search task, the system comprising an interface for communicating to providers hosted on external servers, a cache for storing travel search results for previous travel search tasks served by the providers hosted on external servers and a processor configured to carry out the operations of any one of methods 1 to 13.

In a third general aspect of the present disclosure a computer-readable medium including instructions stored thereon, which when executed by a processor of a computer system make the computer system carry out the operations of any one of methods 1 to 13.

### BRIEF DESCRIPTION OF THE DRAWINGS

FIG. 1 illustrates an example graphical user interface for travel meta-search engine.

FIG. 2 illustrates a schematic drawing of an example travel meta-search engine, multiple remote servers hosting the providers and multiple user devices requesting travel information.

FIG. 3 illustrates an example process for retrieving a search result using a smart cache.

FIG. 4 illustrates another example process for retrieving a search result using a smart cache.

### DETAILED DESCRIPTION

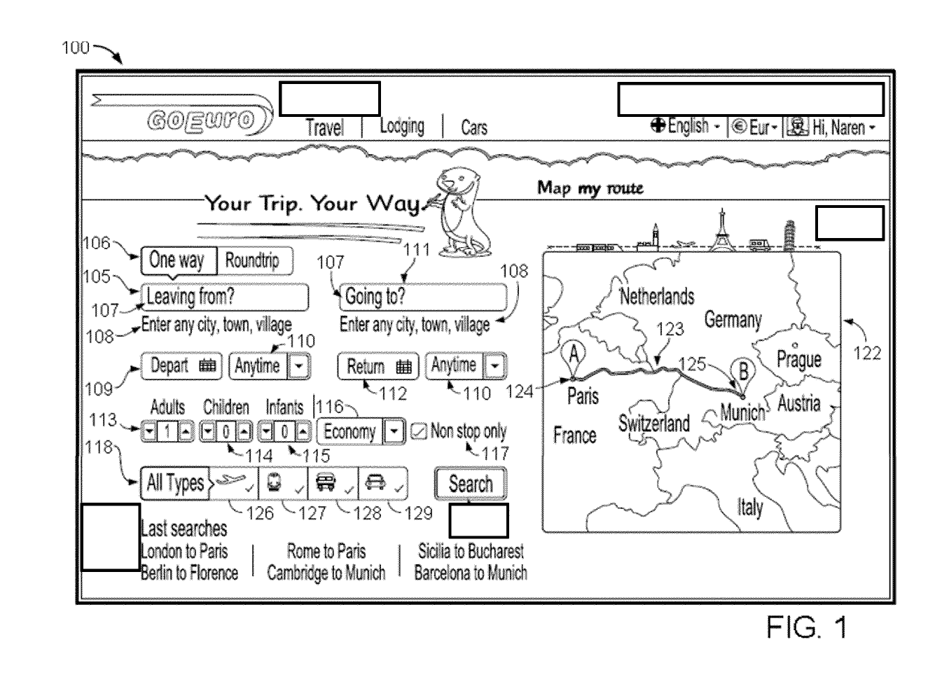

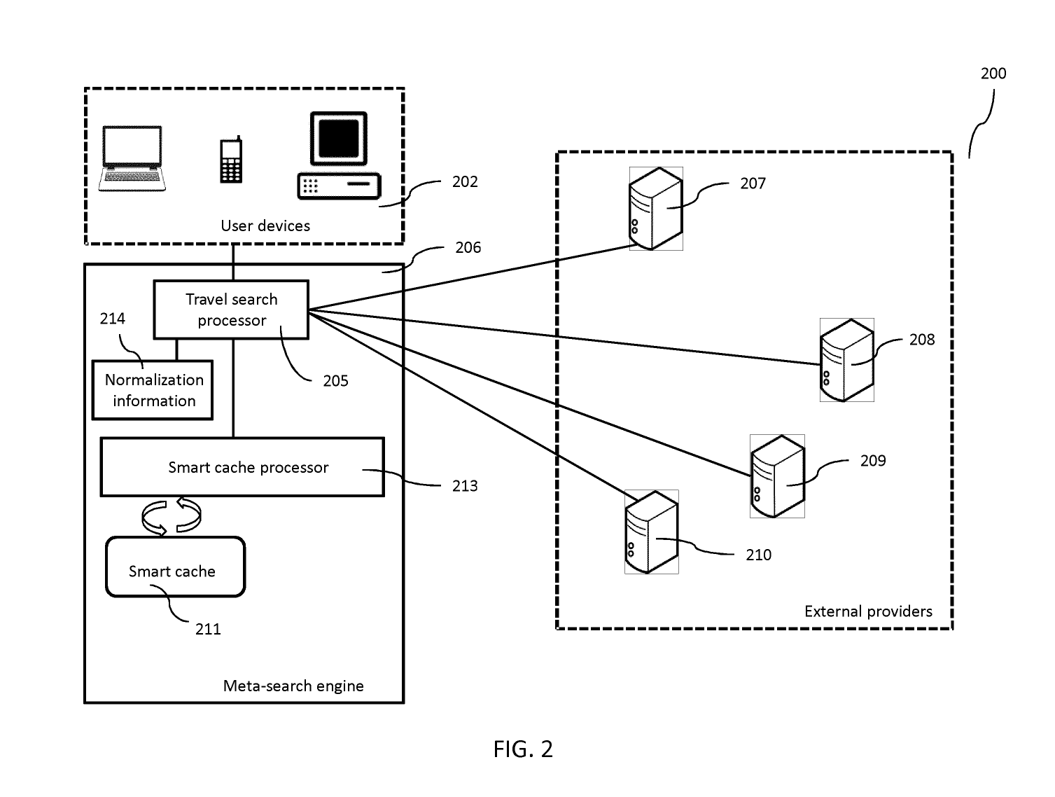

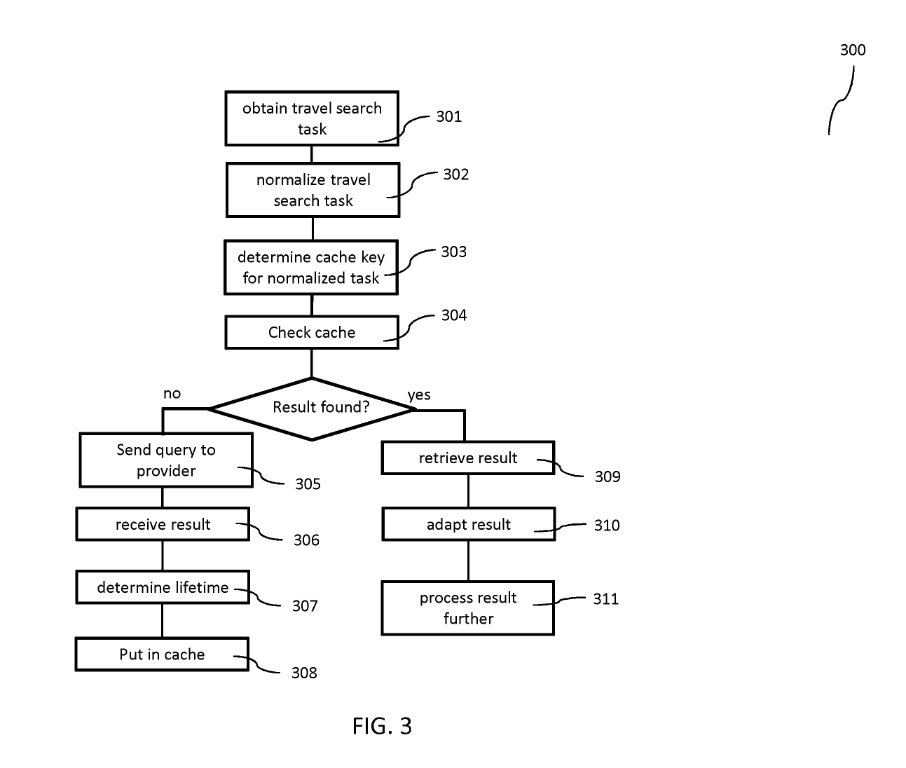

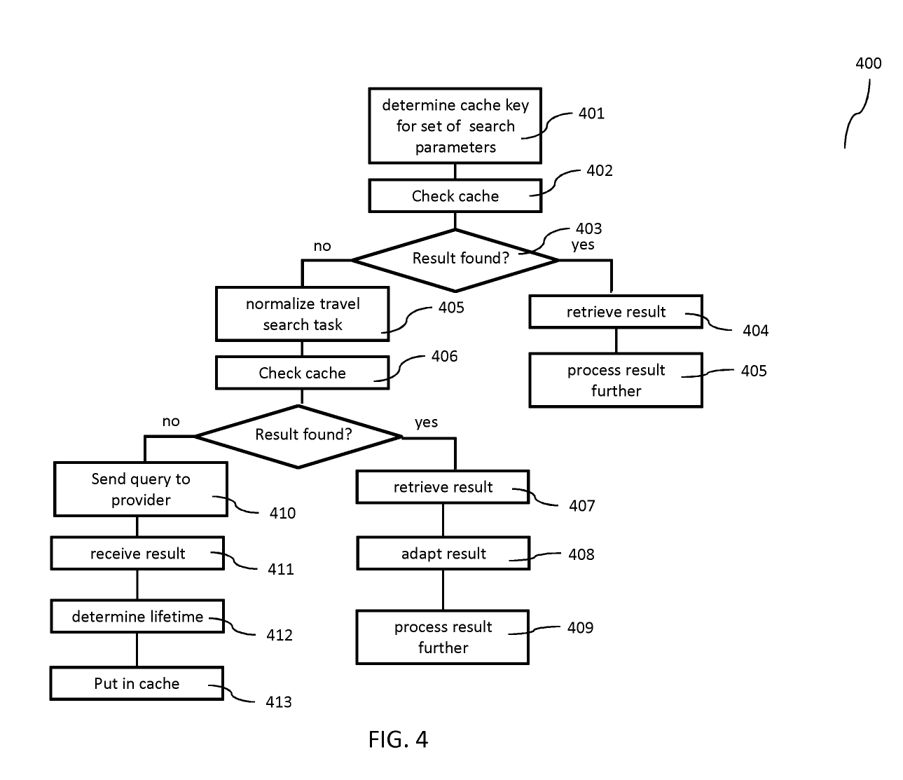

This disclosure relates to a travel meta-search engine. In particular, the present disclosure relates to a smart cache for a travel meta-search engine. Different aspects of user interfaces for receiving travel search requests of a travel meta-search engine will be discussed in connection with FIG. 1. Subsequently, different aspects of a computer network environment hosting a travel-meta search engine will be detailed in connection with FIG. 2. Last, aspects of the methods to retrieve travel search results employing particular caching strategies will be illustrated in connection with FIG. 3 and FIG. 4.

FIG. 1 shows the example graphical user interface 100 of a travel meta-search engine as described in the present disclosure. It is configured to receive a travel search request from a user. As used in the present disclosure, a travel search request received by a user defines a particular journey the user wants to receive travel information for from the travel meta-search engine.

For performing this task of receiving a travel search request from a user, the graphical user interface 100 includes a plurality of input fields that can be used by a user to input travel search parameters. In the example of FIG. 1, the graphical user interface 100 includes input fields for specifying an origin 105, a destination 111, a departure date 109, a departure time 110, a return date 112, a return time 117, a specification of number and type of travelers (e.g., types “adult” 113, “children” 114 and “infants” 115). Moreover, a user finds on the graphical user interface 100 input fields to specify if he or she is interested in a one-way trip or a round trip 106, if only non-stop flights should be included in the set of search results 117, a seat or travel category 116 and a set of transportation means (e.g., “all types” 118, “plane” 126, “train” 127, “bus” 129 or “car” 129).

Via these input fields, a user can specify travel search parameters of a travel search request. The selection of input fields and thus the travel search parameters of FIG. 1 are not limiting. In other examples, a larger or smaller number of travel search parameters can be required or sufficient to specify a travel search request. In addition, it is not necessary in some examples that the user inputs all travel search parameters processed in the travel meta-search engine. For example, predetermined default values for travel search parameters can be specified by the travel meta-search engine to complement an incomplete travel search request. In addition, the travel search parameters processed by the travel meta-search engine do not necessarily have a one-to-one correspondence with the values input in the input fields of the graphical user interface 100. For example, a particular input value can be decomposed into multiple travel search parameters (e.g., a input value specifying a departure date can be decomposed into travel search parameters “departure day,” “departure month” and “departure year”) for further processing. In addition or alternatively, different input values can be combined to a travel search parameter before being processed further. In the present disclosure a “travel search parameter” can specify a single value, multiple values or a range of values. For instance, a number of adult passengers can be an example of a single-valued travel search parameter. A departure time between 6 am and 8 am is an example for a travel search parameter specifying a range of values. Moreover, a travel search parameter can have any suitable format. In addition, an input format of a graphical user interface 100 can be re-formatted before being further processed in the travel meta-search engine. For instance, a user can input a city name or an address in the respective input field of the graphical user interface 100. This input parameter can be processed, e.g., to travel search parameters defining one or more airports nearby the input city name or address. In another example, an input address can be processed into a set of geo-coordinates.

It should be pointed out that the methods and systems disclosed herein are not limited to a use in combination with a particular user interface or to a use in a particular environment on a user device. For instance, the graphical user interface 100 of FIG. 1 might be presented to the user in a web-browser environment. In other examples, dedicated or multi-purpose application software can present the graphical user interface 100 of FIG. 1 to a user (e.g., a smartphone application software). In addition, even though the user interface of FIG. 1 is a graphical user interface 100, the user can also specify his search request via alternative input means (e.g., via voice input). The only requirement for the user interface is that a user must be able to specify a travel search request to be forwarded to the computer system for serving travel search results as described in the present disclosure.

In other examples, the methods and systems discussed in the present disclosure can also be sued to interface with other computer systems. In this situation, a travel search request is not received from a user device but from the other computer system. For instance, the travel search results provided by the methods and systems discussed in the present disclosure could be transmitted to another computer system to be further processed and presented to a user (e.g., the other computer system can be a computer system hosting a provider of travel and accommodation information).

Having said that, an example processing of a travel search request will be described subsequently in connection with FIG. 2. FIG. 2 illustrates a schematic drawing of an example computer network 200 including a travel meta-search engine 206, multiple remote servers 207-210 hosting providers of travel information and multiple user devices 202 for requesting travel information. A “provider” provides travel information which can include schedules, availability and prices. A provider can be a travel operator (e.g. a German railroad company) or an aggregator.

The user device 202 can be any user device 202 suitable for sending a travel search request to a computer system for serving travel search results from multiple different providers 206. For instance, a user device 202 can be a personal computer, a mobile device (e.g., a smartphone) or a workstation of a computer system. The user device 202 can be configured to present a user interface for collecting the travel search request to a user (e.g., the graphical user interface 100 described in connection with FIG. 1 above). In a subsequent operation, the client device 202 sends the specified travel search request search to the travel meta-search engine 206.

Subsequently, an example method will be discussed in which a particular user device receives a travel search request and forwards the travel search request to the travel meta-search engine 206. In subsequent operations the travel search request is processed at the travel meta-search engine 206. Eventually, travel search results are served from the travel meta-search engine 206 to the client devices 202 for presentation to the user.

A particular travel meta-search engine 206 will be described in the following sections. The example travel meta-search engine 206 includes a travel search processor 205, a smart cache processor 213, a smart cache 211 and a travel task normalization information repository 214. The operation of these components will be explained subsequently. Even though these components are illustrated in FIG. 2 as separate entities, the following description only refers to functional units performing the described operations. These functional units can be embodied in any suitable hardware environment, as discussed below. For instance, two or more functional units can be hosted on the same hardware component. On the other hand, a single functional unit can be hosted by multiple hardware components.

After receiving the travel search request, the travel search processor 205 starts processing the travel search request. In a first operation, the travel search processor 205 identifies a set of travel search parameters specified in the travel search request. As described above, this can include processing the travel search request to translate a set of initial travel search parameters into a set of travel search parameters in a format that can be further processed by the travel meta-search engine 206. In one illustrative example, the user has specified a one-way travel search request from Paris to Munich for two persons on May 20, 2014. Moreover, the user has specified a departure time between 6 am and 8 am and has not specified any preferences regarding travel category and transportation means. Thus, a set of travel search parameters for this particular travel search request can be: “origin” (having the value “Paris”), “destination” (having the value “Munich”), “type” (having the value “one-way”), “number of passengers” (having the value “2”), “departure time” (having the value “6am-8an”), “departure date” (having the value “May 20, 2014”) and “category” and “transport means” (both having the value “not specified”).

After a set of travel search parameters has been identified, the travel search processor 205 can identify one or more routes satisfying the user-specified travel search parameters of the travel search request. For instance, the travel search processor 205 can determine that for a journey specified in a particular travel search request two or more different transportation means can be used. In addition, the travel search processor can determine that a journey specified in a particular travel search request can be decomposed into two or more different legs (e.g., a first leg by train followed by a second leg by bus).

In a further operation, the travel search processor 205 can identify one or more relevant external providers serving travel information regarding the identified routes (or legs of the identified routes). A “provider” can be a computer system of a particular transportation company (e.g., a particular bus company or an airline), or another travel meta-search engine (e.g., a travel meta-search engine for air travel), or any other provider of travel information.

In a subsequent operation, the travel search processor 205 can formulate search tasks for a particular provider and a particular identified route (or a leg of a particular identified route). The travel search processor can determine a set of travel search task parameters for each provider-specific travel search task. The travel search task parameters can be derived from the travel search parameters of the original travel search task received from the user. For instance, the user can have specified Berlin as the origin and Munich as the destination of his or her journey. The travel search processor can determine that Berlin Tegel and Berlin Schönefeld are candidate departure airports near the user-specified origin and the airport “Franz-Josef-Strauss” near Munich is a candidate destination airport. Thus, the travel search processor identifies two candidate air routes, a first one from Tegel to Franz-Josef-Strauss and a second one from Schönefeld to Franz-Josef-Strauss. The derived travel search task parameters can be “origin=Berlin Tegel” or “origin=Berlin Schönefeld” and “destination=Munich, Franz-Josef-Strauss.” In addition, the travel search processor can identify a particular German travel meta-search engine for air travel as relevant external provider for travel data. The travel search processor now can formulate two travel search tasks. First, a travel search task to the particular German travel meta-search engine for receiving flight connections between Tegel and Franz-Josef-Strauss, and, second, a travel search task to the particular German travel meta-search engine for receiving flight connections between Schönefeld and Franz-Josef-Strauss. In this manner, the travel search processor can define multiple travel search tasks for the user's travel search request.

After having defined multiple travel search tasks for the user's travel search request, the travel search processors retrieves travel search results for each of the travel search tasks. This can involve transmitting the travel search tasks to suitable external providers hosted on one or more of the multiple remote servers 207-210. After having retrieved travel search results for each of the travel search tasks, the travel search processor can aggregate the travel search results and serve them to the user device 202.

However, as the travel meta-search engine 206 includes a smart cache, not every travel search task might require requesting travel information from external providers hosted on one or more of the multiple servers 207-210. Rather, the travel search processor can first check if suitable travel search results are stored in the smart cache 211 of the travel meta-search engine 206. If this is the case, a request to one or more of the multiple servers 207-210 hosting the providers can be avoided and the travel search result in the smart cache 211 can be used to retrieve suitable results for the travel search task. This process will be illustrated subsequently in connection with FIG. 3 and FIG. 4. The processes described herein rely on normalizing the defined travel search tasks, i.e., at least one travel search parameter is adapted to increase the probability that a suitable search result can be found in the smart cache 211.

FIG. 3 illustrates an example process for retrieving a search result for a travel search task using a smart cache. In one operation, the travel search processor 205 obtains 301 a particular travel search task. In a subsequent operation, the travel search processor 205 generates 302 a normalized travel search task for the obtained travel search task by using search task normalization information stored in the search task normalization information repository 214. In general, normalization of a travel search task includes adapting at least one travel search parameter of the travel search task based on the search task normalization information. Further details and examples of this process will be discussed in the following sections.

Adapting the set of travel search task parameters can include changing one or more value of one or more travel search task parameters, removing one or more travel search task parameters from the normalized travel search task, or marking one or more travel search task parameters to be ignored in the normalized travel search task. In one example, the travel search parameter adaptation process can include provider-specific or transport carrier-specific (e.g., a specific airline or bus company) adaptations. For instance, a number of passengers can be set to one regardless of the actual number of passengers specified in the travel search task parameters. In another example, a particular transport carrier might offer the same set of connections each day or each workday. In this situation, a travel search parameter normalization process can include removing or ignoring the date parameters of the set of travel search task parameters. Thus, a normalized travel search task can include a set of parameters being only a subset of the original travel search task parameters. In still another example, a particular transport carrier might offer the same set of connections each hour. In this situation, a travel search task normalization process can include removing or ignoring hour parameters (and optionally also the date parameters) of the set of travel search parameters. In still another example, a particular transport medium (independent of the carrier or the provider of the travel information) can be served by the same set of connections every day or workday (e.g., all long distance busses have the same schedule each workday). In this situation, a travel search task normalization process can include removing or ignoring the date parameters of the set of travel search parameters, regardless of which particular specific transport carrier serves the connection or from which provider the travel information is to be requested. In still other examples, a particular transport carrier offers a fixed pricing scheme for a predetermined period of time (e.g., the prices of a train company might change once a year at most). Then, a travel search task normalization process can again include removing or ignoring the date parameters. The above-discussed examples can also be combined. For instance, a particular transport carrier can offer the same connections on each day or workday for fixed prices. Then, a travel search task normalization process can again include removing or ignoring the date parameters (or changing the value of the date parameter to “any workday”).

An example search task normalization process will be described in the following. An example travel search task shall retrieve travel information for a journey from Strasbourg to Munich using an articular train company. The travel search task parameters include: “origin” (having the value “Strasbourg”), “destination” (having the value “Munich”), “number of passengers” (having the value “2”), “departure date” (having the value “May 20, 2014”) and “carrier” (having the value “train company A”). The following information can, e.g., be available with respect to train company A: i) Its prices are the same for an entire year. ii) It offers the same set of connection each day. iii) It offers no group tickets. IV) there are no designated seats, availability is not an issue. Thus, the travel meta-search engine 206 can normalize the travel search task to remove the date parameter. In addition, the travel meta-search engine 206 can set the number of passengers to one. Thus, a normalized travel search task can have the following travel search parameters: “origin” (having the value “Strasbourg”), “destination” (having the value “Munich”), “number of passengers” (having the value “1”), and “carrier” (having the value “train company A”).

The travel search task normalization process can be performed at the travel meta-search engine in different ways. For instance, for each provider, transport carrier or transport medium a set of travel search task normalization rules can be defined and stored at the travel meta-search engine. For instance, the travel search task normalization rules can be stored as executable code on the travel-meta-search engine. Then, after defining the one or more travel search tasks for a particular travel search request, the respective rules can be applied to each travel search task to generate the normalized travel search task.

In the above examples, the user device 202 can run a thin client (e.g., in a web-browser) to collect the user input for specifying the travel search request and presenting the travel search results. However, in other examples additional operations of methods to serve results for a travel search request can be split between a client user 202 and a computer system for serving travel search results from multiple different providers 206 in a different fashion. For instance, the input values of the specified travel search request input via a user interface of the client device can be processed into travel search parameters that can be processed further by the travel meta-search engine 206, as described above. In still other examples, the user device can contribute to the travel search task normalization process. In other example, the user device and the computer system for serving travel search results from multiple different providers are integrated in a single computer system.

Returning to the process illustrated in FIG. 3, in a further operation a cache key for the normalized travel search task is generated 303. A cache key can specify a set of attributes, each attribute identifying one or more values of a travel search parameter of the set of travel search parameters of the normalized travel search task. An attribute can include one or more of a one way/round trip attribute, a non stop only attribute, an outbound date attribute, a return date attribute, a number of passengers attribute, a further description of the passengers attribute (age group (adult, senior, child, . . . ), a bonus cards of the passenger(s) attribute, an origin of passenger attribute, a language of passenger attribute, desired cabin type (e.g. first class) attribute, an origin attribute, a destination attribute and a departure time attribute.

In addition, travel search results of previous travel search tasks stored in the cache are also associated with a cache key. The attributes of each cache key identify a set of travel search parameters and their values that were used to retrieve the respective travel search result (or a modified set of previous travel search parameters and their values) associated with the cache key. Thus, in other words, operation 303 described above includes determining a cache key travel search results the current normalized travel search task would be associated with. Therefore, suitable travel search results in the cache can be located by a comparison of the cache key determined for the current normalized travel search task with cache keys of the previous travel search results stored in the cache.

In a further operation, the smart cache can be checked 304 for relevant entries for the normalized travel search task by comparing the cache key of the normalized travel search task to cache keys of travel search results stored in the smart cache 211. In this manner, travel search results for previous travel search tasks in the smart cache can be retrieved 309 and served as part of a travel search result in response to the travel search request, even if the travel search parameters of a current travel search task do not match exactly of the previous travel search tasks (or even if travel search parameters of the current and the previous travel search tasks are markedly different). This can allow retrieving a larger fraction of travel search result from the cache 211 of the travel meta-search engine 206 compared to systems not employing a search parameter adaptation process. As a consequence, a number of requests to external servers can be reduced.

In one additional optional operation, the travel search result retrieved from the cache can be adapted 311 to take into account the adaptation of the travel search parameters in the normalizing operation. This operation can include adding travel information relating to a removed or ignored travel search task parameter in the initial travel search task. Alternatively or in addition, this operation can include changing the search result to adapt to a change in the value of a travel search task parameter in the normalization operation. For instance, if a number of passengers has been changed as part of the normalization operation, the adaptation operation of the travel search result retrieved from the cache can include adapting price information to confirm to the number of passengers in the initial travel search task. E.g., an initial number of five passengers has been normalized to one passenger. The price associated with the de-cached search result for a single passenger can then be multiplied by five to obtain a price corresponding to the initial task in the search result adaptation operation. In another example, if a date parameter or a time parameter has been removed or ignored as part of the normalization operation, the de-cached search results can be adapted to include date or time information corresponding to the date or time information specified in the initial travel search task. In this manner, the search results for the travel search tasks retrieved from the cache can be integrated in the search results served to a user in reply to a travel search query.

Optionally, in one operation (not shown in FIG. 3), before starting the travel search task normalization process, the travel search-meta engine 206 can determine a particular travel search request is a candidate for normalization. The determination can be based on processing one or more of the set of travel parameters. The normalization operations described above can be carried out only if the particular travel search request is a candidate for normalization. In addition or alternatively, particular travel search task can remain unchanged in the process of the travel search normalization process.

It has been described above what can happen if a suitable travel search result for a normalized travel search task can be found in the smart cache 211. If no suitable travel search result can be found, in a subsequent operation a travel search query including the travel search task can be transmitted 308 to an external provider. In one example, this can include transmitting the normalized travel search task to the external provider. In other examples, this can include transmitting the initial search task to the external provider. A corresponding travel search result is received 309 at the travel meta-search engine. The communication with the external provider can take place in different modes. In one example, the external provider offers an application-programming interface for automated travel search request. In other examples, travel information can be retrieved from the external provider by employing data scraping techniques. In one example, screen scraping can be used. Then, the travel meta-search engine can retrieve travel information from an external provider's web page by simulating a human user submitting a travel search request at a web interface of the external provider's web site. The travel search results displayed by the external provider in response to the simulated travel search request can be collected by the travel meta-search engine. If a normalized travel search result is transmitted to the external provider, it can be required to adapt the received search result in the same manner as described above for the de-cached search results before further processing the received search results (e.g., a number of passengers and hence a price is increased).

As described above, the travel meta-search engine can transmit the initial or normalized search tasks to the external provider. In other examples, the travel search engine additionally adapts the initial or normalized travel search tasks to increase the information content of the retrieved search results. This can further reduce a number of search requests to external providers of travel information. For instance, a travel search task for a single adult can be adapted to a travel search task for an adult and a child. In other examples, a time window for connections can be increased in an adapted travel search request. Both examples can increase the information content of the retrieved travel search results and supersede future search requests to the external providers.

By employing the techniques explained above, or by means of alternative techniques, the travel meta-search engine can retrieve travel search replies for particular travel search tasks from external providers. These travel search replies can be combined with search results for other travel search tasks for a particular travel search request of a user and served to the user in reply to the travel search request. The smart cache techniques described herein might allow, in some situations, to serve the travel search results faster than other cache techniques.

In an additional optional step, the received search result can be put 310 in the smart cache to be served in response to future requests. In one example, the travel search results received upon transmitting normalized travel search tasks are stored in the smart cache. In other examples, the received search results are normalized before they are stored in the cache. For instance, if during the normalization process particular travel search parameters are removed (or ignored) from a set of travel search parameters for a particular travel search task, it can nevertheless be necessary to transmit the initial set of travel search requests to an external provider. However, it is not necessary to cache the complete received travel search result in some examples. Rather, particular pieces of information included in the travel search results can be modified or removed before they are stored in the cache. In one example, it can be necessary to include a date search parameter in a travel search request for an external provider. However, because of the reasons discussed above, date information can be dispensable for the particular travel search task (e.g., the same set of connections is served every day). In this situation, the date information can be removed from the travel search results before they are stored in the cache. Upon retrieval of the travel search results from the cache, date information can be added, as discussed above. Both techniques described above—transmitting normalized search tasks and normalizing search results retrieved from the external providers can decrease a size of the cache required for serving a particular percentage of results out of the cache. This can save memory resources and can accelerate the retrieval of search results from the cache.

In one optional operation, a lifetime or an expiration date is determined 307 by the travel meta-search engine for a particular search result before the search result is included in the cache. If the lifetime or the expiration date of a particular travel search result has passed, the travel meta-search engine removes the particular search engine from the cache. The lifetime or the expiration date for a particular search result is determined based on values of travel search parameters of the travel search task in response to which the particular travel search result is retrieved, based on information regarding the provider from which the particular travel search result is retrieved, based on parameters of the travel search result, or a combination of two or more of these factors. In one example, the lifetime is determined based on a number of free seats received from an external provider for a particular travel search task. The lifetime can be shorter for a lower number of free seats. For instance, if a number of free seats is lower than four in an airplane, a lifetime of a travel search result can be, e.g., two hours. If a number of free seats is larger than 20, the lifetime can be, e.g., two days. In other examples, a span of time between the date on which a travel search request is received at the travel meta-search engine and a travel date specified in the travel search request can be taken into account to determine a lifetime of a travel search result. The lifetime can be longer with an increasing time span of time between the date on which a travel search request is received at the travel meta-search engine and a travel date specified in the travel search request. In still other examples, it can be known that a particular carrier changes it schedule at a predetermined date each year or each month. In this situation, the travel search results relating to this carrier can be removed from the cache at the predetermined date. All of the above-described techniques can improve the quality of travel search results retrieved from the smart cache. In addition, a size of the smart cache can be reduced as travel search results are removed from the cache as soon as their potential usefulness drops below a certain threshold.

In connection with FIG. 3, an example process for retrieving a search result using a smart cache has been described in which a travel search task normalization operation is performed on all (or most) of the travel search tasks. FIG. 4 illustrates another process 400 for retrieving a search result using a smart cache. In the example of FIG. 4, the travel meta-search engine determines 401 a cache key for an initial (non-normalized) travel search task. In a further operation, the travel meta-search engine checks 402 if a travel search result satisfying the initial (non-normalized) travel search task can be found in the cache. If this is the case, the particular travel search result can be retrieved 403 from the cache and processed further 404 by the travel meta-search engine in reply to a travel search request by the user. If a suitable travel search result cannot be found in the smart cache, the travel meta-search engine can commence a travel search task normalization process, as described in connection with FIG. 3. Accordingly, for operations 405-413 in FIG. 4, the techniques described in connection with operations 302 to 311 in FIG. 3 can be employed. The process of FIG. 4 might require a larger smart cache than the process of FIG. 3. However, the travel meta-search engine still can benefit from the travel search task normalization techniques (even if the cache is checked for a hit for the original search task in a first step). Thus, the process of FIG. 4 can still require less search requests to external providers or be faster or less error-prone than certain other techniques for travel meta-search engines.

In general, the techniques that we have described can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the invention by operating on input data and generating output. Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks or other forms of latest memory storage technology. The processor and the memory can be supplemented by, or incorporated in special purpose logic circuitry.

To provide for interaction with a user, the techniques can be implemented on a computer having a display device, e.g., a CRT (cathode ray tube), a OLED (organic light emitting display) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. The user can be a person, a computer, or a process, or any other user or supplier of travel data. The interface can be any possible method for information to be passed between a user and the system, including, for example, a user interface, an API, a data feed, a mobile device such as an iPad or a tablet, a mobile app, and machine to machine communication.

The techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

1. A computer-implemented method to retrieve results for a travel search task executed on a computer system hosting a travel meta-search engine, the method comprising:
obtaining a travel search task specifying one or more values of each travel search task parameter of a set of travel search task parameters;
obtaining search task normalization information for the travel search task;
normalizing the travel search task, wherein normalizing the travel search task includes adapting at least one travel search parameter of the travel search task based on the search task normalization information;
determining a cache key corresponding to the normalized travel search task;
determining if a cache of the computer system hosting a travel meta-search engine includes a travel search result for the normalized travel search task, the cache including travel search results of previous travel search tasks indexed by a cache key; and
if the cache includes a travel search result for the normalized travel search task, retrieving the travel search result from the cache.

2. The computer-implemented method of claim 1, further comprising:
if the cache does not include a travel search result for the normalized travel search task, retrieving the travel search result from a provider hosted on a computer system external to the computer system hosting the travel meta-search engine.

3. The computer-implemented method of claim 1, further comprising:
adapting the travel search result retrieved from the cache to take into account the adaptation of at least one travel search parameter in the normalizing operation.

4. The computer-implemented method of claim 1, wherein adapting at least one travel search parameter of the travel search task includes changing the one or more values of the at least one travel search task parameter or removing the travel search parameter in the normalized travel search task, or marking the at least one travel search parameter to be ignored in the normalized travel search task.

5. The computer-implemented method of claim 1, wherein the travel search task is a provider-specific travel search task for retrieving travel data from a particular provider hosted on a computer system external to the computer system hosting the travel meta-search engine.

6. The computer-implemented method of claim 1, wherein the cache key specifies a set of attributes of the respective travel search result, wherein each attribute identifies one or more values of a travel search parameter of a travel search task for which the particular travel search result was retrieved.

7. The computer-implemented method of claim 6, wherein the attributes can include one or more of a one way/round trip attribute, a non-stop only attribute, an outbound date attribute, a return date attribute, a number of passengers attribute, a further description of the passengers attribute, a bonus cards of the passenger(s) attribute, an origin of passenger attribute, a language of passenger attribute, desired cabin type attribute, an origin attribute, a destination attribute and a departure time attribute.

8. The computer-implemented method of claim 1, wherein the search task normalization information for the travel search task is selected such that a probability is increased that travel search results retrieved from providers hosted on a computer system external to the computer system hosting the travel meta-search engine in response to the normalized travel search task can be re-used in future travel search tasks.

9. The computer-implemented method of claim 1, wherein the search task normalization information includes provider-specific information for one of a plurality of providers hosted on a computer system external to the computer system hosting the travel meta-search engine the travel meta-search engine retrieves travel search data from.

10. The computer-implemented method of claim 1, wherein each travel search result in the cache has a lifetime or an expiration date, the method further comprising removing the travel search result from the cache if the lifetime or the expiration date of the search result has passed.

11. The computer-implemented method of claim 10, wherein the lifetime or the expiration date for a particular search result is determined based on values of travel search parameters of the travel search task in response to which the particular travel search result is retrieved, based on information regarding the provider from which the particular travel search result is retrieved, based on parameters of the travel search result, or a combination of two or more of these factors.

12. The computer-implemented method of claim 1, wherein the travel search task is one of one or more travel search tasks for a travel search request, further comprising:
obtaining the travel search request from a user, the travel search request specifying a set of travel search request parameters;
defining the one or more travel search tasks for the obtained travel search result, each travel search task specifying a set of travel search parameters;
obtaining search task normalization information for each of the travel search tasks;
normalizing each travel search task;
determining a cache key corresponding to each normalized travel search task;
determining if the cache of the computer system hosting a travel meta-search engine includes a travel search result for the normalized travel search tasks; and
if the cache includes travel search result for the normalized travel search tasks, retrieving the travel search result from the cache.

13. The computer-implemented method of claim 1, wherein the travel meta-search engine is configured to provide travel search results for one or more or two or more different transportation means.

14. A computer system to retrieve results for a travel search task, the system comprising:
an interface for communicating to providers hosted on external servers;
a cache for storing travel search results for previous travel search tasks served by the providers hosted on external servers; and
one or more processors configured to perform operations, the operations comprising:
obtaining a travel search task specifying one or more values of each travel search task parameter of a set of travel search task parameters;
obtaining search task normalization information for the travel search task;
normalizing the travel search task, wherein normalizing the travel search task includes adapting at least one travel search parameter of the travel search task based on the search task normalization information;
determining a cache key corresponding to the normalized travel search task;
determining if a cache of the computer system hosting a travel meta-search engine includes a travel search result for the normalized travel search task, the cache including travel search results of previous travel search tasks indexed by a cache key; and
if the cache includes a travel search result for the normalized travel search task, retrieving the travel search result from the cache.

15. A computer-readable medium including instructions stored thereon, which when executed by one or more processors of a computer system allow the computer system to perform operations comprising:
obtaining a travel search task specifying one or more values of each travel search task parameter of a set of travel search task parameters;
obtaining search task normalization information for the travel search task;
normalizing the travel search task, wherein normalizing the travel search task includes adapting at least one travel search parameter of the travel search task based on the search task normalization information;
determining a cache key corresponding to the normalized travel search task;
determining if a cache of the computer system hosting a travel meta-search engine includes a travel search result for the normalized travel search task, the cache including travel search results of previous travel search tasks indexed by a cache key; and
if the cache includes a travel search result for the normalized travel search task, retrieving the travel search result from the cache.

16. The computer system of claim 14, wherein the operations further comprise if the cache does not include a travel search result for the normalized travel search task, retrieving the travel search result from a provider hosted on a computer system external to the computer system hosting the travel meta-search engine.

17. The computer system of claim 14, wherein the operations further comprise adapting the travel search result retrieved from the cache to take into account the adaptation of at least one travel search parameter in the normalizing operation.

18. The computer system of claim 14, wherein the adaptation of the at least one travel search parameter of the travel search task includes changing the one or more values of the at least one travel search task parameter or removing the travel search parameter in the normalized travel search task, or marking the at least one travel search parameter to be ignored in the normalized travel search task.

19. The computer system of claim 14, wherein the cache key specifies a set of attributes of the respective travel search result, wherein each attribute identifies one or more values of a travel search parameter of a travel search task for which the particular travel search result was retrieved.

20. The computer system of claim 14, wherein:
the travel search task is one of one or more travel search tasks for a travel search request; and
the operations further comprise:
obtaining the travel search request from a user, the travel search request specifying a set of travel search request parameters;
defining the one or more travel search tasks for the obtained travel search result, each travel search task specifying a set of travel search parameters;
obtaining search task normalization information for each of the travel search tasks;
normalizing each travel search task;
determining a cache key corresponding to each normalized travel search task;
determining if the cache of the computer system hosting a travel meta-search engine includes a travel search result for the normalized travel search tasks; and
if the cache includes travel search result for the normalized travel search tasks, retrieving the travel search result from the cache.
